(19) United States
(12) Patent Application Publication
(10) Pub. No.: US 2015/0052107 A1
(43) Pub. Date: Feb. 19, 2015

(54) OBJECT DEPENDENCY MANAGEMENT

(71) Applicants: Lyric Pankaj Doshi, Cambridge, MA (US); Benjamin M. Vandiver, Arlington, MA (US); Charles Edward Bear, Hudson, MA (US)

(72) Inventors: Lyric Pankaj Doshi, Cambridge, MA (US); Benjamin M. Vandiver, Arlington, MA (US); Charles Edward Bear, Hudson, MA (US)

(21) Appl. No.: 14/375,594

(22) PCT Filed: Apr. 30, 2012
(86) PCT No.: PCT/US2012/035787

§ 371 Date: Jul. 30, 2014

(51) Int. Cl. G06F 17/30

(52) U.S. Cl. CPC G06F 17/30548; G06F 17/30309; G06F 17/30575
USPC 707/638

(57) ABSTRACT

A method for object dependency management for historical access includes assigning versions to states of a structure for storing objects, and assigning the versions to dependency changes between the objects. The method further includes managing historical access to the objects based on an analysis of the versions and the dependency changes between the objects.

### BACKGROUND

A database often includes objects, such as tables, stored in a database catalog. The objects may represent metadata related to actual data. Performance of a query related to an object is often based, for example, on the efficiency of location and retrieval of the object from the database catalog. Objects are also often considered to be related to each other based on dependencies. Factors such as the number of objects, the dependency structure of objects, changes to the dependency structure, etc., typically impact the efficiency of query performance.

### BRIEF DESCRIPTION OF DRAWINGS

Features of the present disclosure are illustrated by way of example and not limited in the following figure(s), in which like numerals indicate like elements, in which:

FIG. 1 illustrates an architecture of an object dependency management apparatus, according to an example of the present disclosure;

FIG. 2 illustrates a layout of global and session contexts, according to an example of the present disclosure;

FIG. 3 illustrates a method for object dependency management, according to an example of the present disclosure;

FIG. 4 illustrates further details of a method for object dependency management, according to an example of the present disclosure; and

FIG. 5 illustrates a computer system, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

An object dependency management apparatus and method are described herein and provide snapshot and versioned read access, for example, to a database catalog or any structure generally for storing objects or related to storage of objects. Use of multiple contexts to allow for varying context-level refinement is also provided. The apparatus and method also provide for maintenance of object dependencies for facilitating efficient query performance and historical access. For example, the apparatus and method maintain versioned dependencies such that version numbers that uniquely identify each particular state of the database catalog are maintained and may be associated with a snapshot.

For the object dependency management apparatus and method, an object may be defined as any entity, such as a value, variable, function, or data structure, that is manipulated by machine readable instructions. For example, for objects related to a table and a user, a table may depend on the user who has ownership of the table. For example, an analysis of objects from a user viewpoint may need to determine all the tables that depend on a user. Further, an analysis of objects from a table viewpoint may need to determine which user a table depends from. The dependencies may be used, for example, to determine which tables should be dropped when a user is dropped or to determine which tables to audit given a user that is currently logged into a database. Every object may depend on more than one object and objects may have multiple dependents.

In order to provide concurrent access to the database catalog or other structure, the object dependency management apparatus includes a snapshot module. The snapshot module assigns appropriate version numbers to all changes (i.e., adds, edits, and drops) to an object so that references to a database catalog may filter between changes made before and after the requested version. Consider the following objects: a user-U, a user-V and a table-T. An add may be defined as the table-T being added as a dependent to user-U or user-V. An edit may be defined as a modification to the table-T. A drop may be defined as the table-T being removed as a dependent from user-U or user-V. The snapshot module maintains lists of added and dropped dependencies which hold object identifications (IDs) and the version in which they were added or dropped. Upon access, the adds and drops are resolved to determine which IDs were added but not yet dropped at the access requested version. As snapshots are closed, according to an example, a cleanup module uses an amortized approach to efficiently cleanup stale dependencies that will be seen as dropped to all existing and future snapshots.

To reduce shared lock contention and thereby increase performance, the snapshot module allows users to acquire a snapshot, or a consistent view of the database catalog at a given logical time, and continue to access that view until the user releases the snapshot. The view is consistent if none of the object properties or dependencies change in the eyes of the user when the snapshot is accessed, regardless of what changes may have occurred in the database catalog itself since the snapshot was accessed. Thus, on subsequent reads of the database catalog, the user may observe the state of the database catalog and the dependencies between its objects as they existed at the time of the snapshot. The user may not observe any further changes in the database catalog that occur after the snapshot was acquired, including the adding and dropping of objects. A subsequent snapshot would however observe the adds and drops. Therefore, the snapshot module generally supports reads against snapshots taken at different times.

The object dependency management apparatus and method also provide for the organization of objects using multiple contexts, or tiers, that form a tree structure and are accessed in a linear hierarchy from a leaf to the root. For example, a global context module may be provided for maintaining a global context for the database catalog and a session context module may be provided for maintaining multiple session contexts for each database session. Thus, the global context takes into account all changes to dependencies of objects, and the session contexts are based on a state of the database catalog at a specific time of a query related to an object. Thus, a session is specific to a user's connection to the database in that while some changes may exist in the user's session for them to observe and disappear when the session ends, other changes are committed to the global context. Further, multiple users may access a database catalog and obtain results specific to their own session contexts. Moreover, changes made by a particular user to a dependency of an object may be committed to the global context to then be viewed by subsequent users, while users who accessed the database catalog prior to the changes would not see the changes in their particular sessions. When determining the characteristics of an object from a lower context (i.e., a lower tier session context), access may begin with the root context (i.e., the global context) and proceed to the requesting context (i.e., the specific lower tier session context), applying changes from each intermediate context (i.e., each intermediate session context) along the way. Therefore, two sessions may see the same state from the global context, but each may maintain and apply their own unique changes at the session context level. The use of multiple contexts to differentiate and layer changes also provides a concise and organized way to manage alterations to the database catalog.

The object dependency management apparatus and method disclosed herein provide for the support of dependency queries against multiple fully-consistent snapshots of the database catalog in an order-of-growth runtime-efficient manner while maintaining space-efficient storage. Thus, each concurrent read of the database catalog observes changes made before the beginning of the reading process, even though the database catalog is constantly being updated. The cost of maintaining the dependencies is amortized over the adds, drops, and accesses to the database catalog.

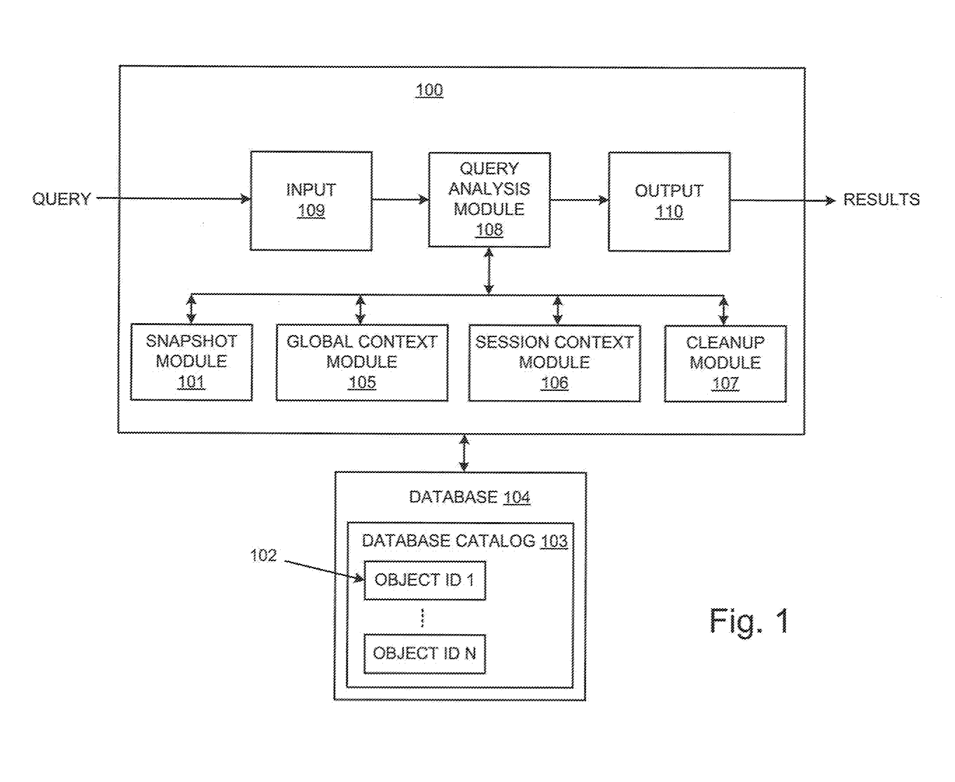

FIG. 1 illustrates an architecture of an object dependency management apparatus 100, according to an example. Referring to FIG. 1, the apparatus 100 is depicted as including a snapshot module 101 to assign appropriate version numbers to all changes (i.e., adds, edits, and drops) to an object 102 so that references to a database catalog 103 of a database 104 may distinguish between changes made before and after the requested version. The version numbers uniquely identify each particular state of the database catalog 103 and are associated with a snapshot. A global context module 105 may be provided for maintaining a global context for the database catalog 103. A session context module 106 may be provided for maintenance of multiple session contexts for database sessions (e.g., a session context or multiple session contexts for each database session). A cleanup module 107 may use an amortized approach to efficiently remove dependencies that will be seen as dropped to all existing and future snapshots. A query analysis module 108 may receive a query at input 109. Based on the query, the query analysis module 108 may access the modules 101 and 105-107, and the database 104, to generate results at output 110.

The modules 101 and 105-108, and other components of the apparatus 100, may comprise machine readable instructions stored on a computer readable medium. In addition, or alternatively, the modules 101 and 105-108, and other components of the apparatus 100 may comprise hardware or a combination of machine readable instructions and hardware.

According to an example, the snapshot module 101 assigns appropriate version numbers (e.g., version numbers 1, 2, 3 . . . n) to all changes (i.e., adds, edits, and drops) to the dependency of the objects 102 so that references to the database catalog 103 can filter between changes made before and after the requested version. For example, as discussed above, for the objects user-U, user-V and table-T, the snapshot module 101 assigns appropriate version numbers to all changes to the dependency of these objects. Generally, the snapshot module 101 maintains two version ID lists per given object. An add version ID list is maintained for all the objects that are added as dependents to a given object, including the version at which they are added. A drop version ID list is maintained for all the objects that are dropped as dependents to a given object, including the version at which they are dropped. For example, for the objects user-U, user-V and table-T, adding a table-T as a dependent to a user-U results in the add version ID list for user-U being updated to reflect the addition of table-T. The snapshot module 101 may assign version number 1 to the addition of the table-T as a dependent to the user-U. In this case, no change would be made to the add or drop version ID lists for user-V. Similarly, dropping the table-T as a dependent from the user-U results in the drop version ID list for user-U being updated to reflect the dropping of table-T. The snapshot module 101 may assign version number 2 to the dropping of the table-T as a dependent from the user-U. Likewise, in this case, no change would be made to the add or drop version ID lists for user-V. The snapshot module 101 may assign subsequent version numbers to the adding or dropping of the table-T as a dependent to or from the user-U. Similarly, the snapshot module 101 may assign version numbers to the adding or dropping of the table-T as a dependent to the user-V. For example, adding the table-T as a dependent to the user-V results in the add version ID list for user-V being updated to reflect the adding of table-T. The snapshot module 101 may assign version number 3 to the adding of the table-T as a dependent from the user-V. In this case, no change would be made to the add or drop version ID lists for user-U.

When a query is made for historical access related to an object 102 stored in the database catalog 103, the query specifies the version at which the dependents are desired. For example, for a query related to the objects user-U, user-V and table-T, a query may specify retrieval of a version-x (e.g., version-2 or version-3) of a table-T related to user-U (or user-V). This version number may be used to sweep added and dropped object lists. For example, the version number may be used to add objects created at or below that version to a result list and remove any objects with drops at that version or below.

In order to account for the added and dropped objects for the result list, the result list may be based on the principle that every add has a corresponding drop in the current context or in a higher one. Therefore, resolving from the root context (i.e., global context) to requesting contexts ensures this invariant of add before drop is maintained. Further, the same ID may be added multiple times as long as there is a drop at a version in between each time the ID is added.

Since snapshot versions are monotonically increasing (i.e., every change increments the version number), the cleanup module 107 (described in further detail below) may permanently remove matching add-drop pairs whenever the version of the drop is lower than the lowest version of all the snapshots currently live (i.e., snapshots that are currently in use). Further, the cleanup module 107 may permanently remove matching add-drop pairs whenever the version of the drop is lower than the latest version of the database catalog 103 if there are no currently live snapshots.

An example of operation of the object dependency management apparatus 100 is described for further facilitating a description of the operation of the global and session context modules 105, 106, and the cleanup module 107.

In an example including objects user-U and dependent tables T1 and T2, table T1 may be designated by ID 1 and the table-T2 may be designated by ID 2. The following operations may be performed on objects ID 1 and ID 2:

i) Add dependent ID 1 at version 1.

ii) Add dependent ID 2 at version 2.

iii) Drop dependent ID 2 at version 3.

iv) Drop dependent ID 1 at version 4.

v) Add dependent ID 1 at version 5

The add and drop version ID lists for user-U related to dependent tables T1 (i.e., ID 1) and T2 (i.e., ID 2) are as follows (ID, version):
Add version ID list: (1,1), (2,2), (1,5)
Drop version ID list: (2,3), (1,4)

When a query is made for historical access related to objects ID 1 or ID 2 stored in the database catalog 103, the query specifies the version at which the dependents are desired. For example, based on the analysis performed by the query analysis module 108, a query at version 1 will not find any drops and will find the add of ID 1. Thus, for the query received at the input 109 related to version 1, the result list would result in the object ID 1 generated by the output 110.

In another application of the foregoing example, based on the analysis performed by the query analysis module 108, a query at version 2 will not find any drops and will find the adds of objects IDs 1 and 2. Thus, for the query received at the input 109 related to version 2, the result list would result in the objects IDs 1 and 2 generated by the output 110.

In a further application of the foregoing example, based on the analysis performed by the query analysis module 108, a query at version 3 will find a drop of object ID 2, then find the corresponding add of object ID 2 and remove it from consideration. Finally, the query at version 3 will find the add of object ID 1. Thus, for the query received at the input 109 related to version 3, the result list would result in object ID 1 generated by the output 110.

In yet another application of the foregoing example, based on the analysis performed by the query analysis module 108, a query at version 5 will first find an unmatched add for object ID 1 at version 5, meaning that object ID 1 will be part of the result list. This is followed by matched adds and drops for object IDs 1 and 2 at the lower versions, which are thus ruled out. This is because there should not be consecutive adds without a drop in between for the same ID. Thus, for the query received at the input 109 related to version 5, the result list would result in object ID 1 generated by the output 110.

Thus, based on a query received at the input 109, the query may include a specific version at which the state of dependent IDs (i.e., the dependent IDs that have already been added and have not yet been dropped), is desired. If no version is provided, the query is assumed to be based on the highest version. Based on the version, the query analysis module 108 may first iterate the add and drop version ID lists for the particular objects subject to the query until any versions greater than the request version are omitted. This is because any versions greater than the requested version are not part of the result set. For example, in the foregoing example for the query at version 3, the query analysis module 108 ignores the dependent ID 1 drop at version 4. The query analysis module 108 then effectively merges the add and drop version ID lists, while taking into account that every drop has a corresponding add. Specifically, the add and drop version ID lists may be iterated in decreasing version order, with all drops being temporarily saved and the adds being checked against the temporarily saved drops. In the foregoing example for the query at version 3, the query analysis module 108 may begin by temporarily saving object ID 2 because it was dropped at version 3. Because the query analysis module 108 iterates in decreasing version order, the drop for any add that does have a corresponding drop will be seen before seeing the add. Therefore, any added ID not found as a drop in the temporary structure is part of the result set. Continuing with the foregoing example for the query at version 3, a corresponding add is found for the drop on object ID 2, ruling object ID 2 out of the result set, and an add without a drop for object ID 1. Thus, for the query received at the input 109 related to version 3, the result list would result in object ID 1 generated by the output 110.

Operation of the global context module 105 is described for maintaining a global context for the database catalog 103. Further, operation of the session context module 106 is described for maintaining multiple session contexts for database sessions (e.g., a session context or multiple session contexts for each database session).

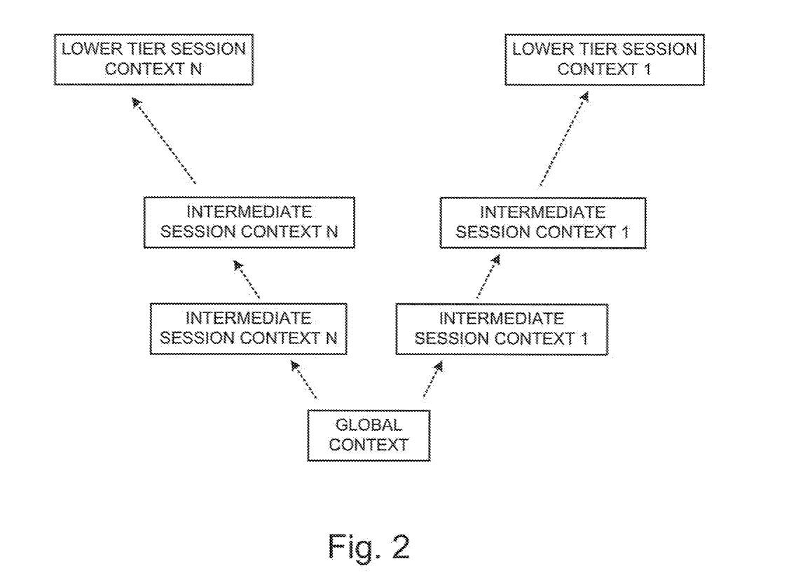

The global context module 105 provides for maintenance of a global context for the database catalog 103. Further, the session context module 106 provides for maintenance of multiple session contexts for database sessions (e.g., a session context or multiple session contexts for each database session). Thus, the global context takes into account all changes to dependencies of objects, and the session contexts are based on a state of the database catalog at a specific time of a query related to an object. Referring to FIG. 2, when determining the characteristics of an object from a lower context (i.e., a lower tier session context), access may begin with the root context (i.e., the global context) and proceed to the requesting context (i.e., the specific lower tier session context), applying changes from each intermediate context (i.e., each intermediate session context) along the way. Therefore, two sessions may see the same state from the global context, but each may maintain and apply their own unique changes at the session context level.

For multiple, layered contexts (i.e., the global and session contexts), while the foregoing aspects related to drops having corresponding adds remains applicable, multiple, layered contexts make it possible for these pairings to cross context boundaries. For example, for the foregoing query example related to user-U that includes dependent tables T1 and T2 (i.e., objects ID 1 and ID 2), the global context module 105 may add a global context based dependency (1,1) and the session context module 106 may add a session context based refinement with a drop of (1,4). In order to handle the session context, the session context module 106 may separate its dropped ID list into two lists. The first drop ID list may be determined as described earlier (i.e., the foregoing drop version ID list). The second dropped ID list may hold IDs that do not have corresponding adds in the context. The separated dropped ID lists may be created during access by moving drops that do not find matching adds to the second dropped ID list. By querying a higher session context for its dependents (which may recursively query its higher session context, if one exists) and removing IDs from the result set that are found in the second dropped ID list, the correct dependents result set remains. Specifically, the correct dependents result set that accounts for all the refinements by lower contexts against the content of higher contexts remains.

Operation of the cleanup module 107 which uses an amortized approach to efficiently remove dependencies is described.

While iterating the add and drop version ID lists for access, any add or drop pairs older than the version being currently used may be deleted entirely. In order to improve efficiency of access to the database catalog 103, the cleanup module 107 may amortize cleanup costs of stale add/drops. For example, when the number of new drops equals the number of adds outstanding, the cleanup module 107 may detect matching pairs of adds and drops that may have become stale. This ensures that the database catalog 103 will never exceed having double the number of IDs (i.e., each ID has an add and a drop) because of staleness. As long as a snapshot is open at a particular version number, no ID with a greater drop version may be considered to be stale and neither may its corresponding add.

The efficiency of the cleanup module 107 is further demonstrated by considering an unamortized implementation that stores the current state of all the dependencies at every snapshot. That is, every snapshot actually replicates the full dependency structure and associates it with the snapshot. This unamortized implementation will provide correct results. If there are k snapshots for an object with an average of n dependencies each per snapshot and c changes to the dependencies between subsequent snapshots (c being much smaller than n), the unamortized implementation will be time efficient. This is because the unamortized implementation may be used to locate the dependencies for a given snapshot in O(lg k), for example, with C++ stl-style maps and then iterate them to build the result set in O(n). However, the unamortized implementation will be expensive in terms of space and will be O(k*n). Compared to the foregoing amortized implementation provided by the cleanup module 107, the runtime is O(n+c) to output the dependents at a given version. Likewise, for the foregoing amortized implementation provided by the cleanup module 107, the space use is O(n+c). Thus the foregoing amortized implementation provided by the cleanup module 107 provides both time and space efficiency.

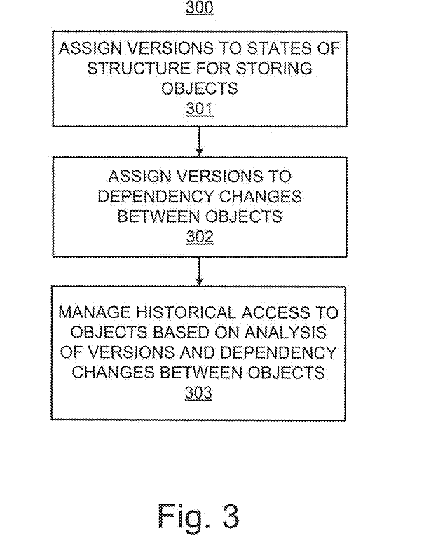

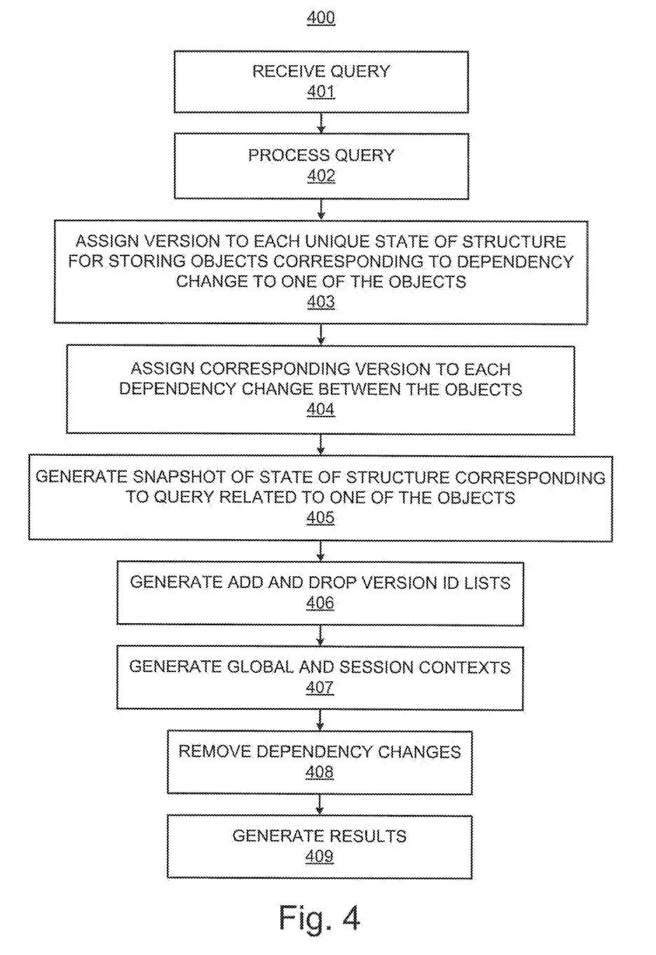

FIGS. 3 and 4 illustrate flowcharts of methods 300 and 400 for object dependency management for historical access, corresponding to the example of an object dependency management apparatus 100 whose construction is described in detail above. The methods 300 and 400 may be implemented on the object dependency management apparatus 100 with reference to FIGS. 1 and 2 by way of example and not limitation. The methods 300 and 400 may be practiced in other apparatus.

Referring to FIG. 3, for the method 300, at block 301, versions may be assigned to states of a structure for storing objects. For example, referring to FIG. 1, the snapshot module 101 may assign appropriate version numbers to all changes (i.e., adds, edits, and drops) to the object 102 so that references to the database catalog 103 of the database 104 may filter between changes made before and after the requested version. The version numbers uniquely identify each particular state of the database catalog 103 and are associated with a snapshot.

At block 302, the versions may be assigned to dependency changes between the objects. For example, referring to FIG. 1, the snapshot module 101 assigns appropriate version numbers (e.g., version numbers 1, 2, 3 . . . n) to all changes (i.e., adds, edits, and drops) to the dependency of the objects 102 so that references to the database catalog 103 may filter between changes made before and after the requested version.

At block 303, historical access to the objects may be managed based on an analysis of the versions and the dependency changes between the objects. For example, referring to FIG. 1, based on a query, the query analysis module 108 may access the modules 101 and 105-107, and the database 104, to manage historical access to the objects based on an analysis of the versions and the dependency changes between the objects, and generate results at output 110.

Referring next to FIG. 4, for the method 400, at block 401, a query is received. For example, referring to FIG. 1, the query analysis module 108 may receive a query at input 109. The query may be related to an object 102 stored in the database catalog 103 of the database 104.

At block 402, based on the query, the query analysis module 108 may access the appropriate modules to process the query. For example, referring to FIG. 1, based on the query, the query analysis module 108 may access the modules 101 and 105-107.

At block 403, a version may be assigned to each unique state of a structure for storing objects corresponding to a dependency change to one of the objects. For example, referring to FIG. 1, the snapshot module 101 may assign appropriate version numbers to all changes (i.e., adds, edits, and drops) to the object 102 so that references to the database catalog 103 of the database 104 may fitter between changes made before and after the requested version. The version numbers uniquely identify each particular state of the database catalog 103 and are associated with a snapshot.

At block 404, a corresponding version may be assigned to each dependency change between the objects. For example, referring to FIG. 1, the snapshot module 101 assigns appropriate version numbers (e.g., version numbers 1, 2, 3 . . . n) to all changes (i.e., adds, edits, and drops) to the dependency of the objects 102 so that references to the database catalog 103 may filter between changes made before and after the requested version.

At block 405, a snapshot of a state of the structure corresponding to the query related to one of the objects may be generated. For example, referring to FIG. 1, the snapshot module 101 may generate a snapshot of a state of the structure (e.g., database catalog 103) corresponding to the query related to one of the objects.

At block 406, an add version ID list for all objects that are added as dependents to a given object may be generated. Further, a drop version ID list for all objects that are dropped as dependents from a given object may be generated. The add and drop version ID lists may be used to determine a dependency state of an object. For example, the add and drop version ID lists may be iterated in decreasing version order to determine the dependency state of the object.

At block 407, a global context of the states of the structure corresponding to all of the versions of the states of the structure may be generated. Further, a session context corresponding to a state of the structure based on a time of a query related to one of the objects may be generated. For example, referring to FIG. 1, the global and session contexts may be generated by the global and session context modules 105, 106.

At block 408, the dependency changes between the objects may be removed by amortizing adds, drops and accesses to the structure. For example, the dependency changes between the objects may be removed by amortizing dependency changes that are no longer needed for historical access. For example, referring to FIG. 1, the cleanup modules 107 may be used to remove dependency changes between the objects.

At block 409, the results based on the query may be generated. For example, referring to FIG. 1, based on the query, the query analysis module 108 may access the modules 101 and 105-107, and the database 104, to generate results at output 110.

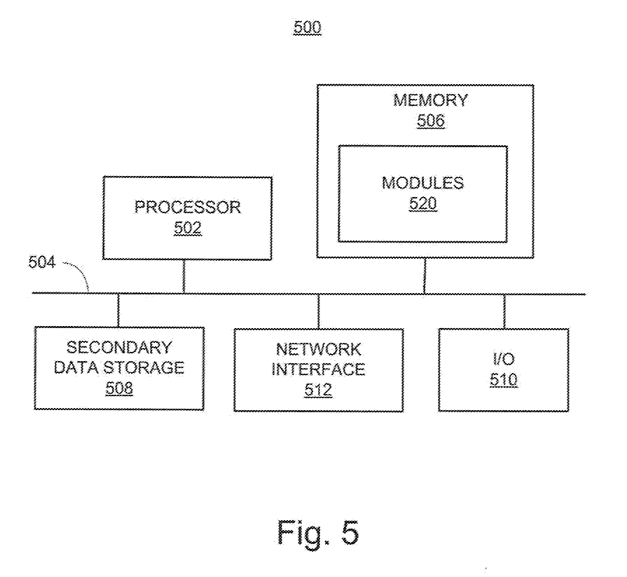

FIG. 5 shows a computer system that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 502 that may implement or execute machine readable instructions performing some or all of the methods, functions and other processes described herein. Commands and data from the processor 502 are communicated over a communication bus 504. The computer system also includes a main memory 506, such as a random access memory (RAM), where the machine readable instructions and data for the processor 502 may reside during runtime, and a secondary data storage 508, which may be non-volatile and stores machine readable instructions and data. The memory and data storage are examples of computer readable mediums. The memory 506 may include modules 520 including machine readable instructions residing in the memory 506 during runtime and executed by the processor 502. The modules 520 may include the modules 101 and 105-108 of the apparatus shown in FIG. 1.

The computer system may include an I/O device 510, such as a keyboard, a mouse, a display, etc. The computer system may include a network interface 512 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for object dependency management for historical access, the method comprising:
assigning versions to states of a structure for storing objects;
assigning the versions to dependency changes between the objects; and
managing, by a processor, historical access to the objects based on an analysis of the versions and the dependency changes between the objects.

2. The method of claim 1, further comprising:
assigning a version to each unique state of the structure corresponding to a dependency change to one of the objects; and
assigning a corresponding version to each dependency change between the objects.

3. The method of claim 1, wherein the dependency changes include adding, editing and dropping of the objects.

4. The method of claim 1, further comprising:
associating the versions to snapshots of the states of the structure, wherein a snapshot includes information related to dependency of the objects.

5. The method of claim 1, further comprising:
generating a snapshot of a state of the structure corresponding to a query related to one of the objects.

6. The method of claim 1, further comprising:
generating a global context of the states of the structure corresponding to all of the versions of the states of the structure; and
generating a session context corresponding to a state of the structure based on a time of a query related to one of the objects.

7. The method of claim 1, further comprising:
removing the dependency changes between the objects by amortizing adds, drops and accesses to the structure.

8. The method of claim 1, further comprising:
removing the dependency changes between the objects by amortizing dependency changes that are no longer needed for historical access.

9. The method of claim 1, further comprising:
generating an add version ID list for all objects that are added as dependents to a given object;
generating a drop version ID list for all objects that are dropped as dependents from a given object; and
using the add and drop version ID lists to determine a dependency state of an object.

10. The method of claim 9, wherein using the add and drop version ID lists further comprising:
iterating the add and drop version ID lists in decreasing version order to determine the dependency state of the object.

11. An object dependency management apparatus comprising:
a memory storing a module comprising machine readable instructions to:
assign a version to a state of a structure corresponding to a dependency change between objects;
assign a corresponding version to the dependency change between the objects; and
manage historical access to the objects based on an analysis of appropriate versions and corresponding dependency changes between the objects; and
a processor to implement the module.

12. The apparatus of claim 11, wherein the structure is a database catalog.

13. The apparatus of claim 11, wherein the machine readable instructions are to:
generate a snapshot of a state of the structure corresponding to a query related to one of the objects.

14. The apparatus of claim 11, wherein the machine readable instructions are to:
generate a global context of states of the structure corresponding to all versions of the states of the structure; and
generate a session context corresponding to a state of the structure based on a time of a query related to one of the objects.

15. A non-transitory computer readable medium having stored thereon machine readable instructions for object dependency management for historical access, the machine readable instructions when executed cause a computer system to:
assign versions to states of a structure related to storage of objects;
assign the versions to dependency changes between the objects;
manage, by a processor, historical access to the objects based on an analysis of the versions and the dependency changes between the objects;
generate a global context of the states of the structure corresponding to all of the versions of the states of the structure; and
generate a session context corresponding to a state of the structure based on a time of a query related to one of the objects.
